(19) United States
(12) Patent Application Publication
(10) Pub. No.: US 2020/0255307 A1
(43) Pub. Date: Aug. 13, 2020

(54) METHOD OF PROCESSING THIN STILLAGE

(71) Applicant: KURITA WATER INDUSTRIES, LTD., Tokyo (JP)

(72) Inventors: Keith GERFEN, Olathe, KS (US); Nick MUSSELMAN, Olathe, KS (US)

(73) Assignee: KURITA WATER INDUSTRIES, LTD., Tokyo (JP)

(21) Appl. No.: 16/788,697

(22) Filed: Feb. 12, 2020

Related U.S. Application Data
(60) Provisional application No. 62/804,960, filed on Feb. 13, 2019.

(51) Int. Cl. C02F 1/52; C02F 1/38; C02F 1/24; C12F 3/10; A23K 10/38

(52) U.S. Cl. CPC C02F 1/5263; C02F 1/385; C02F 2103/32; C12F 3/10; A23K 10/38; C02F 1/24

(57) ABSTRACT

A method of processing thin stillage in an ethanol manufacturing operation that involves treating thin stillage upstream of an evaporator with a treatment system that includes a chitosan flocculant, thereby forming a mixture of water and flocculated solids, and separating the water from the flocculated solids with a solid-liquid separation device to form clarified thin stillage.

### CROSS-REFERENCE TO RELATED APPLICATIONS

The present application claims priority to U.S. Provisional Patent Application No. 62/804,960, filed Feb. 13, 2019. The content of the application is incorporated herein by reference in its entirety.

### BACKGROUND OF THE INVENTION

### Field of the Invention

The present invention relates to a method of processing thin stillage.

### Discussion of the Background

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The production of ethanol (both food and transportation fuel grades) from biomass such as corn is a mature technology. However, fuel ethanol production has repeatedly faced commercial viability obstacles relative to petroleum. Current technologies allow for about 2.5 gallons (wet mill process) and 2.8 gallons (dry mill process) of ethanol per bushel of corn. The salability of valuable co-products such as wet distillers grains with solubles (WDGS) and dried distillers' grains with solubles (DDGS) as animal feed strengthen the overall economic viability of the process (Kim, Y. et al. Composition of corn dry-grind ethanol by-products: DDGS, wet cake, and thin stillage, Bioresource Technology, 2008, 99, 5165-5176—incorporated herein by reference in its entirety). While ethanol production is an energy-efficient process today, additional research is occurring to make improvements to the energy-efficiency and to increase the yields of high value co-products.

Ethanol production from corn using dry milling processes involves breaking down the corn into component sugars. Corn is typically milled in a hammer mill, gelatinized in slurry tanks, and subjected to cooking/liquefaction/saccharification processes to break down the biomass into glucose which is used as feed for fermentation. Many methods are known for breaking down biomass into component sugars, such as acid hydrolysis treatments (U.S. Pat. Nos. 4,384,897; 4,650,689; 5,975,439) and enzymatic hydrolysis steps involving one or more enzymatic treatments with α-amylase, β-amylase, glucoamylase, pullulanase, and granular starch hydrolyzing enzymes (GSHE) (National Renewable Energy Laboratory (NREL) report entitled “Lignocellulose Biomass to Ethanol Process Design and Economics of Co-Current Dilute Acid Prehydrolysis and Enzymatic Hydrolysis Current and Future Scenarios”, NREL/IP-580-26157, July 1999; Chaplin, M. F. et al., Enzyme Technology, Cambridge University Press, 1990—incorporated herein by reference in its entirety).

The monosaccharides are fermented with yeast to produce a beer mash, which is an aqueous slurry containing 10 to 12% ethanol, along with yeast cells and residuals from the milled corn kernels remaining after fermentation. The beer is then processed with a distillation unit to remove/rectify the ethanol, leaving behind non-volatile components as a product called whole stillage in the fuel ethanol industries and thick slop in the beverage industry. Whole stillage contains about 11 to 15 wt. % solids made up of any fiber, oil, protein, germ, gluten, hull, and other unfermented components of the grain and yeast cells that pass through the process.

Horizontal dewatering centrifuges (decanter) separate whole stillage into a wastewater fraction called thin stillage (or centrate), and a solid fraction called wet distillers' grains. The whole stillage centrifuges are only effective in capturing a portion of the suspended solids in the whole stillage and so a considerable portion of the smaller particles/fines and/or the larger sheared particles are discharged into the thin stillage. Thus, thin stillage typically contains 6 to 10 wt. % solids, with about 2 to 4 wt. % being suspended solids and about 4 to 6 wt. % being present as dissolved solids.

Thin stillage can be processed or used in a number of different ways within the plant; the decision as to how the thin stillage stream will be split and processed in a particular plant is based upon the economics of each available option. Typically, a significant volume fraction of the thin stillage is sent back to the head of the plant as make-up water for the slurry tanks, referred to as backset. It is common for plants to use at least 15% of the thin stillage as backset (Bothast, R. J. et al. Biotechnological processes for conversion of corn into ethanol, Appl. Microbiol. Biotechnol., 2005, 67, 19-25; Kwiatkowski, J. R. et al. Modeling the process and costs of fuel ethanol production by the corn dry-grind process, Industrial Crops and Products 23, 2006, 288-296—each incorporated herein by reference in its entirety), and sometimes as much as 50% of thin stillage is recycled as backset. Industry tends to re-use backset because it reduces the need for additional fresh water in front end processes, thereby lowering water costs. The balance of the thin stillage stream is concentrated through multiple effect evaporators to produce a syrup called condensed distillers' solubles (CDS) with a solids content commonly between 28 and 46 percent by weight (Ganesan, V. et al., Methodology to determine soluble content in dry grind ethanol coproduct streams, Appl. Eng. Agric. 2006, 22, 899-903—incorporated herein by reference in its entirety). CDS may then be blended with the wet distillers' grains from the whole stillage centrifuges to form wet distillers' grains with solubles (WDGS) which may be sold as an animal feed. To improve the shelf-life, the WDGS may be fed through feed dryers to produce an animal feed product known as dry distillers' grains with solubles (DDGS), which has a >88% by weight solids content (Kim, Y. et al. Composition of corn dry-grind ethanol by-products: DDGS, wet cake, and thin stillage, Bioresource Technology, 2008, 99, 5165-5176; Bothast, R. J. et al. Biotechnological processes for conversion of corn into ethanol, Appl. Microbiol. Biotechnol., 2005, 67, 19-25—each incorporated herein by reference in its entirety).

A corn-to-ethanol production plant generates about 6 gallons of thin stillage per gallon of ethanol, which equates to about 550 to 600 gallons of thin stillage per minute (US20080153149A1—incorporated herein by reference in its entirety). Such high volumes of thin stillage (wastewater) is problematic for several reasons: i) concentrating thin stillage into CDS is one of the most energy intensive processes in corn ethanol refineries, ii) the relatively high solids content of thin stillage can cause evaporator fouling during concentration operations, leading to decreased capital and increased operating costs (e.g., requires de-fouling), iii) thin stillage may impair and/or poison upstream enzymatic processes when large amounts are recycled as backset due to high levels of impurities and organic compounds (for example high biological oxygen demand, BOD, and/or chemical oxygen demand, COD), and iv) the suspended materials sent back to front end processes continually increase in concentration each time the backset is recaptured, and as a result, the shear energy requirement placed on separation equipment such as the whole stillage centrifuge perpetually increases.

One strategy for overcoming such challenges involves the use of flocculants to effectively clarify thin stillage prior to evaporation to CDS or recycling (backset) procedures. Traditionally, acrylamide-based flocculants (i.e., acrylamide monomers and/or polyacrylamides) have been employed for this purpose, such as those described in US20060006116A1, US2007/0210007A1, and U.S. Pat. No. 9,776,105B2—each incorporated herein by reference in its entirety. However, acrylamide-based flocculants may have limitations that prevent their use in many plants. 1) acrylamide monomers are widely considered toxic and unsafe for consumption, which is problematic since the end use of recovered solids from whole stillage/thin stillage is for animal feed. Current AAFCO (Association of American Feed Control Officials) guidance is to minimize acrylamide levels. Polyacrylamide flocculants, while being generally recognized as safe (GRAS) as substances intended for addition to animal feeds, are a possible acrylamide contamination source due to risks of depolymerization to acrylamide monomers and/or through the release of residual polymer-entrapped acrylamide monomers (Bratby, J., Coagulation and flocculation in water and wastewater treatment, IWA Publishing, London, 2006; Xiong, B. et al., Polyacrylamide degradation and its implications in environmental systems, Nature, npj Clean Water, 2018, 1, 17—each incorporated herein by reference in its entirety). Polyacrylamides are thus tightly regulated by the FDA and must meet certain requirements including a minimum molecular weight of 3 million Daltons, a viscosity range of 3,000 to 6,000 cP at 77° F., and must have a residual acrylamide content of not more than 0.05% (U.S. Food & Drug Administration, 21 CFR573.120). The stigma surrounding acrylamide-based flocculants has many in the industry searching for non-toxic alternatives. 2) Polyacrylamides returned in the backset to the slurry tanks can build/cycle up in upstream processes and equipment, which can require shut down time for cleaning and can impact the nutritional value of the co-products used as animal feed. 3) As a distillation bottoms product, whole stillage and eventually thin stillage is produced at temperatures between 65° C. and 95° C., and many conventional flocculating agents begin to degrade at such temperatures, requiring the thin stillage to be cooled prior to treatment, which increases energy costs and slows production.

### SUMMARY OF THE INVENTION

In view of the forgoing, there is an ongoing need for improved solids/liquids separation technologies and methods for processing thin stillage that increase the capture of salable co-products, effectively clarify thin stillage so that it may be safely used as backset, involve the use of non-toxic materials approved by GRAS/AAFCO/FDA for use in animal feed, and boost the energy efficiency of ethanol manufacturing operations, for example, by not requiring the thin stillage to be pre-cooled prior to treatment.

Accordingly, it is one object of the present invention to provide novel methods of processing thin stillage in an ethanol manufacturing operation by treating thin stillage upstream of an evaporator with a treatment system that includes a chitosan flocculant to form a mixture of water and flocculated solids, and separating the water from the flocculated solids with a solid-liquid separation device to form clarified thin stillage.

These and other objects, which will become apparent during the following detailed description, have been achieved by the inventors' discovery that chitosan flocculants are effective at clarifying thin stillage over a wide range of pH and temperatures, leading to significant improvements in salable co-product capture and energy/cost efficiency.

Thus, the present invention provides:

(1) A method of processing thin stillage in an ethanol manufacturing operation comprising:

treating thin stillage upstream of an evaporator with a treatment system comprising a chitosan flocculant, thereby forming a mixture of water and flocculated solids; and

separating the water from the flocculated solids with a solid-liquid separation device to form clarified thin stillage.

(2) The method of (1), wherein the chitosan flocculant is derived from chitin of animal sources.

(3) The method of (1), wherein the chitosan flocculant is derived from chitin from fungal fermentation.

(4) The method of any one of (1) to (3), wherein the chitosan flocculant has a degree of deacetylation of 80 to 90%.

(5) The method of any one of (1) to (4), wherein the chitosan flocculant has a weight average molecular weight of 5,000 to 400,000 Daltons.

(6) The method of any one of (1) to (5), wherein the chitosan flocculant is introduced into the thin stillage in the form of an acidic solution comprising the chitosan flocculant and at least one acid selected from the group consisting of acetic acid, lactic acid, citric acid, adipic acid, malic acid, sulfuric acid, and hydrochloric acid.

(7) The method of (6), wherein a weight percent of the chitosan flocculant in the acidic solution is from 0.5 to 2 wt. %, based on a total weight of the acidic solution.

(8) The method of any one of (1) to (7), wherein the chitosan flocculant has a viscosity of 2,000-5,000 cP, based on a 2 wt. % solution of the chitosan flocculant in an acidic solution of 1 wt. % acetic acid.

(9) The method of any one of (1) to (8), wherein the thin stillage is treated with 20 to 50 ppm of the chitosan flocculant, based on a total weight of the thin stillage.

(10) The method of any one of (1) to (9), wherein the treatment system further comprises at least one process aid selected from the group consisting of a secondary flocculant, a coagulant, and a settling aid.

(11) The method of any one of (1) to (10), wherein the thin stillage has a pH of 3 to 6.

(12) The method of any one of (1) to (11), wherein the thin stillage is treated when at a temperature of 65 to 95° C.

(13) The method of any one of (1) to (12), wherein the treatment system is substantially free of an acrylamide-based flocculant.

(14) The method of any one of (1) to (13), wherein the solid-liquid separation device is at least one centrifuge selected from the group consisting of a decanter, a tricanter, and a stacked disc centrifuge.

(15) The method of any one of (1) to (13), wherein the solid-liquid separation device is a dissolved air flotation device.

(16) The method of any one of (1) to (15), wherein the mixture is fed into the solid-liquid separation device at a feed rate of 400 to 800 gallons per minute.

(17) The method of any one of (1) to (16), further comprising aging the mixture for 1 minute to 10 hours prior to the separating.

(18) The method of any one of (1) to (17), wherein the clarified thin stillage contains less than 1 wt. % solids.

(19) The method of any one of (1) to (18), further comprising recycling at least a portion of the clarified thin stillage as backset to slurry tanks.

(20) The method of any one of (1) to (19), further comprising combining the flocculated solids with wet distillers' grains produced upstream during whole stillage processing.

The foregoing paragraphs have been provided by way of general introduction, and are not intended to limit the scope of the following claims. The described embodiments, together with further advantages, will be best understood by reference to the following detailed description.

### DETAILED DESCRIPTION OF THE INVENTION

In the following description, it is understood that other embodiments may be utilized and structural and operational changes may be made without departure from the scope of the present embodiments disclosed herein.

### Definitions

As used herein, the phrase “substantially free”, unless otherwise specified, refers to a composition/material which contains less than 1 wt. %, preferably less than 0.5 wt. %, more preferably less than 0.1 wt. %, even more preferably less than 0.05 wt. %, yet even more preferably less than 0.001 wt. %, yet even more preferably 0 wt. % of a particular component, relative to a total weight of the composition/material.

As used herein, the terms “optional” or “optionally” means that the subsequently described event(s) can or cannot occur or the subsequently described component(s) may or may not be present (e.g., 0 wt. %).

As used herein, “whole stillage” means that non-volatile portion of an ethanol processing stream remaining after a fermentation beer has passed through a distillation process where ethanol has been removed, while “thin stillage” means that portion of an ethanol processing stream remaining after the whole stillage has passed through a centrifuge (or in some cases a press/extruder) where the more heavy wet cake (wet distillers' grains) has been removed. Also, “stillage” is used herein as a general term for whole stillage, thin stillage, or both.

As used herein, “condensed distillers' solubles”, or CDS, means that portion of thin stillage that has passed through a concentration or evaporation process to form a syrup.

As used herein in reference to process streams, “at least a portion” refers to at least 1%, preferably at least 5%, preferably at least 10%, preferably at least 15%, preferably at least 20%, preferably at least 25%, preferably at least 30%, preferably at least 35%, preferably at least 40%, preferably at least 45%, preferably at least 50%, and up to 100%, preferably up to 95%, preferably up to 90%, preferably up to 85%, preferably up to 80%, preferably up to 75%, preferably up to 70%, preferably up to 65%, preferably up to 60%, preferably up to 55% of a process stream being used/routed as described (with the percent either in terms of weight % when dealing with solids processing or volume % when dealing with processing of liquid streams).

As used herein, “(meth)acrylate” denotes both acrylate and methacrylate groups. In other words, the parenthetical “(meth)” should be read as optional. Further, “acrylate” is used generally to refer to both acrylic acid-based compounds and acrylic ester-based compounds.

As used herein, an “acrylamide-based” material refers to an acrylamide monomer, a polyacrylamide formed from polymerization of an acrylamide monomer, or both. Further, “acrylamide monomer” means acrylamide (CH₂=CHC(O)NH₂) or any monomer derived from acrylamide such as mono-N-substituted acrylamides or N,N-disubstituted acrylamides.

“Aged” refers to the time that the thin stillage is left to sit in contact with or is otherwise kept in contact (i.e., mixed or stirred) with the treatment system, prior to being separated. Thus the aging time is the amount of time in between introduction of the treatment system to the thin stillage and the separation operation(s).

### Thin Stillage Processing Methods

The method of the present disclosure is suitable for enhancing solid-liquid separation in thin stillage process streams generated during the production of ethanol from the fermentation of grains including corn, rice, rye, barley, malts, and the like. The method is particularly suitable for thin stillage process streams generated in processing of corn to ethanol.

Such methods generally involve i) treating at least a portion of thin stillage upstream of an evaporator in an ethanol manufacturing operation with a treatment system that includes a chitosan flocculant and optionally at least one process aid selected from the group consisting of a secondary flocculant, a coagulant, and a settling aid, thereby forming a mixture of water and flocculated solids (flocs), and ii) separating the water from the flocculated solids with a solid-liquid separation device to form clarified thin stillage.

It has been discovered that chitosan flocculants, alone or in combination with one or more process aids including a secondary flocculant, a coagulant, and a settling aid, can significantly improve the agglomeration of suspended/dissolved solids in thin stillage, leading to the formation of a stable floc that may be easily separated by a wide array of solid-liquid separation devices. As a result, a clarified thin stillage stream containing very few solids can be sent back to the head of the process as backset, and the flocculated solids may be collected and combined with other valuable co-products to increase the yield of salable animal feed (e.g., WDGS and/or DDGS).

### Treatment—Treatment System

### Chitosan Flocculant

In the methods of the present disclosure, thin stillage is treated with a treatment system downstream of the horizontal dewatering centrifuges (where the thin stillage is formed from whole stillage) and upstream of the evaporators. The treatment system employed herein includes a chitosan flocculant, which is extremely effective at generating a mixture of water and flocculated/agglomerated solids that remain in suspension and are capable of being easily separated from the water.

Chitosan, the deacylated form of chitin, is a linear polysaccharide composed of randomly distributed β(1→4O)-linked D-glucosamine (deacetylated unit) and N-acetyl-D-glucosamine (acetylated unit). Chitosan may be made by treating the chitin shells of crab, shrimp, squid, and other crustaceans or the cell walls of fungi either by enzymatic preparations or chemical hydrolysis using any procedure known by those of ordinary skill in the art, for example as disclosed in U.S. Pat. Nos. 7,544,785B2, 4,195,175A, and US20040215005A1—each incorporated herein by reference in its entirety.

Chitosan materials derived from various sources, and having various chemical/physical properties (e.g., degree of deacetylation (DD), molecular weight distribution, viscosity, etc.) are generally effective flocculants in the thin stillage treatment methods of the present disclosure.

The chitosan flocculant employed herein may be derived from chitin of animal sources, preferably shrimp shells. Alternatively, the chitosan flocculant may be derived from chitin of non-animal sources, preferably from fungal fermentation.

The degree of deacetylation reflects the balance between the two kinds of monomeric residues in chitosan, and is defined as the molar fraction of deacylated units present, i.e., the average number of deacylated units (β-(1→4)-linked D-glucosamine) divided by the sum of the average number of both deacylated and acylated units, expressed as a percentage (Balazs, N., Sipos, P., Limitations of pH-potentiometric titration for the determination of the degree of deacetylation of chitosan, Carbohydrate Research, 342 (1), 124-130, 2007—incorporated herein by reference in its entirety). In some embodiments, the chitosan flocculant has a degree of deacetylation (DD) of at least 40%, preferably at least 50%, preferably at least 60%, preferably at least 70%, preferably at least 72%, preferably at least 74%, preferably at least 75%, preferably at least 78%, preferably at least 80%, preferably at least 82%, preferably at least 85%, and up to 99%, preferably up to 98%, preferably up to 96%, preferably up to 95%, preferably up to 93%, preferably up to 90%, preferably up to 88%. The DD may be determined by any method known by those of ordinary skill, for example, by NMR, IR, acid-base titrimetry, potentiometer titrimetry, or first derivative UV spectroscopy (Khan, T. A. et al. Reporting the degree of deacetylation values of chitosan: the influence of analytical methods, J Pharm. Pharmaceut. Sci. 2002, 5(3):205-212; Jiang, T. D. Chitosan; Chemical industry press: Beijing, China, 2001; pp. 91, 100, 108; Broussignac, P. Un polymere natural pecu cannu dans 1′ industrie e chitosane. Chim. Ind.-Genie Chim. 1970, 99, 1241-1247; Muzzarelli, R. A. A.; Rocchetti, R. Determination of the degree of acetylation of chitosans by first derivative ultraviolet spectrophotometry. Carbohydr. Polym. 1985, 5, 461-472; Yuan, Y. et al. Materials, 2011, 4, 1399-1416—each incorporated herein by reference in its entirety).

In some embodiments, the chitosan flocculant has a weight average molecular weight of at least 5,000 Daltons, preferably at least 10,000 Daltons, preferably at least 25,000, preferably at least 50,000 Daltons, preferably at least 75,000 Daltons, preferably at least 100,000 Daltons, preferably at least 125,000 Daltons, preferably at least 150,000 Daltons, and up to 400,000 Daltons, preferably up to 375,000 Daltons, preferably up to 325,000 Daltons, preferably up to 300,000 Daltons, preferably up to 275,000 Daltons, preferably up to 250,000 Daltons, preferably up to 200,000 Daltons, preferably up to 175,000 Daltons, as determined for example by size exclusion chromatography. However, chitosan flocculants having a weight average molecular weight outside of these ranges may also be employed in some circumstances.

The chitosan flocculant may be introduced into the thin stillage in the form of an acidic solution, for example an aqueous solution containing at least one acid. Suitable acids include, but are not limited to, formic acid, acetic acid, citric acid, propionic acid, butyric acid, lactic acid, adipic acid, malic acid, ascorbic acid, sulfuric acid, and hydrochloric acid. In preferred embodiments, the treatment system includes the chitosan flocculant in acetic acid, lactic acid, citric acid, adipic acid, malic acid, sulfuric acid, and/or hydrochloric acid. The concentration of the acid in the acidic solution may vary depending on the chitosan polymer and the acid employed, however, the chitosan is preferably dissolved in dilute acid, for example acidic solutions made of anywhere from 0.5 wt. %, preferably from 1 wt. %, preferably from 2 wt. %, and up to 10 wt. %, preferably up to 5 wt. %, preferably up to 4 wt. %, preferably up to 3 wt. % acid (w/w). The weight percent of the chitosan flocculant in the acidic solution may be up to 3 wt. %, preferably up to 2 wt. %, preferably up to 1 wt. %, preferably up to 0.5 wt. %, preferably up to 0.1 wt. %, based on the weight of chitosan flocculant (active) per total weight of the acidic solution.

In some embodiments, the chitosan flocculant has a viscosity (as a 2 wt. % solution in 1 wt. % acetic acid) of at least 2,000 cP, preferably at least 2,500 cP, preferably at least 3,000 cP, preferably at least 3,500 cP, preferably at least 4,000 cP, preferably at least 4,100 cP, preferably at least 4,200 cP, preferably at least 4,250 cP, and up to 5,000 cP, preferably up to 4,800 cP, preferably up to 4,600 cP, preferably up to 4,400 cP, preferably up to 4,300 cP, preferably up to 4,260 cP as determined by a viscometer (e.g., Brookfield viscometer made by AMETEK Brookfield) at 25° C. In some embodiments, the chitosan flocculant has a viscosity (as a 0.5 wt. % solution in 0.5 wt. % acetic acid) of at least 500 cP, preferably at least 600 cP, preferably at least 700 cP, preferably at least 800 cP, preferably at least 900 cP, preferably at least 1,000 cP, preferably at least 1,100 cP, preferably at least 1,200 cP, and up to 3,000 cP, preferably up to 2,500 cP, preferably up to 2,000 cP, preferably up to 1,800 cP, preferably up to 1,600 cP, preferably up to 1,400 cP as determined by a viscometer (e.g., Brookfield viscometer made by AMETEK Brookfield) at 25° C.

The use of chitosan flocculants is particularly advantageous for thin stillage treatments because their physical/chemical characteristics and thus clarifying properties may be adjusted to meet the demands of a particular ethanol production plant (e.g., the amount and types of solids/oils present in a particular thin stillage stream, the temperature during treatment, the pH of the thin stillage, the feed rate of the thin stillage stream to be treated, the separation equipment utilized, etc.). For example, chitosan flocculants may be selected for a particular treatment system based on their degree of deacetylation (DD), molecular weight distribution, and/or viscosity, according to the chitin source and method of preparation.

A specific example of a chitosan flocculant that can be employed herein for the processing of thin stillage is FREMONT 8374, which is an organic, cationic chitosan polymer with a degree of deacetylation (DD) of 86-87.6%, and a viscosity of 4,251 cP (as a 2 wt. % solution in 1 wt. % acetic acid) or 1,324 cP (as a 0.5 wt. % solution in 0.5 wt. % acetic acid), commercially available from Fremont, a Kurita company.

The effective dosage, addition point(s) and mode of addition of the chitosan flocculant to the thin stillage process stream can be empirically determined by a person of ordinary skill in the art to obtain the proper polymer/particle interaction and treatment program performance. Typically, the thin stillage is treated with at least 5 ppm, preferably at least 10 ppm, preferably at least 15 ppm, preferably at least 20 ppm, preferably at least 25 ppm, preferably at least 30 ppm, and up to 500 ppm, preferably up to 400 ppm, preferably up to 300 ppm, preferably up to 200 ppm, preferably up to 150 ppm, preferably up to 100 ppm, preferably up to 75 ppm, preferably up to 60 ppm, preferably up to 50 ppm, preferably up to 40 ppm of the chitosan flocculant (active), based on a total weight of the thin stillage. The active amount is based on the amount of chitosan polymer actually dosed, so for example, when the chitosan flocculant is in the form of an acidic solution, the thin stillage is treated with an amount of the acidic solution sufficient to provide the treated thin stillage with the above ppm concentrations of the chitosan polymer. The above dosages are based on normal operating conditions common to ethanol production plants. If needed, the flocculant dosage may be adjusted to values outside of the above ranges depending on several factors including the amount and properties of the thin stillage solids, available mixing energy, the solid-liquid separation device(s) used, the influent flow rate of thin stillage, the process conditions, etc.

Chitosan has a pH working range of 3 to 10.5, making it well-suited for use in stillage process streams in ethanol manufacturing operations, which are typically discharged from distillation units at a pH of 3 to 6, more particularly 4 to 5, or about 4.5, due to the production of CO₂ during fermentation. The method may optionally include adjusting the pH of the thin stillage prior to, or during, treatment with the treatment system. Such a pH adjustment step may be accomplished by the addition of various acids or bases, including both mineral acids and bases as well as organic acids and bases, to any stillage process stream, preferably thin stillage. Acceptable acids and bases include, but are not limited to, acetic acid, citric acid, propionic acid, butyric acid, sulfuric acid, phosphoric acid, lime, and soda.

Chitosan also has a working range of up to about 300° F. (149° C.) before the start of polymer degradation. This compares favorably to traditional flocculation chemistry which tends to degrade beginning around 140° F. (60° C.). In most ethanol production plants, whole stillage (and eventually thin stillage) is discharged from the distillation units at elevated temperatures from around 150° F. (65° C.) and as high as 203° F. (95° C.). Therefore, traditional thin stillage treatment processes often require pre-cooling the thin stillage process stream prior to treatment to avoid degradation of the flocculating agents or to maximize flocculation/separation performance, which of course comes at the expense of energy and efficiency costs. Chitosan's working temperature range spans all ethanol distillation operating temperatures, which is a distinct advantage over traditional flocculation chemistry, since it allows for the thin stillage to be treated with the chitosan flocculant at any temperature received from the centrifuges of a particular plant, i.e., doesn't require system cooling operations prior to treatment. While the thin stillage may be effectively treated at lower temperatures, in preferred embodiments, the thin stillage is not pre-cooled, and is treated while at a temperature of at least 65° C., preferably at least 70° C., preferably at least 75° C., preferably at least 80° C., and up to 95° C., preferably up to 90° C., preferably up to 85° C.

In preferred embodiments, the chitosan flocculant is a linear polysaccharide containing only β-(1→4)-linked D-glucosamine and N-acetyl-D-glucosamine monomer units (those monomer units associated with deacetylated natural chitin), and is substantially free of other reacted monomer types. Alternatively, the chitosan flocculant may be a blended copolymer of chitosan and one or more additional polymer types. Suitable additional polymer types that may be blended with chitosan include, but are not limited to, polyethylene glycol, polyamides, polyethylene, poly(meth)acrylates, gelatin, polyvinyl alcohol, polylactic acid, polycaprolactone, collagen, celluloses (e.g., carboxymethyl cellulose), silk fibroin, carrageenan, pectin, as well as mixtures thereof. In some embodiments, when a blended copolymer of chitosan and one or more additional polymer types is employed, chitosan is the predominant polymer. In some embodiments, a weight ratio of chitosan to the one or more additional polymer types is greater than 1:1, preferably greater than 2:1, preferably greater than 3:1, preferably greater than 4:1, preferably greater than 5:1, and up to 30:1, preferably up to 20:1, preferably up to 15:1, preferably up to 10:1. Such blended copolymers may be prepared by solution blending or melt blending as is known in the art.

In addition to chitosan polymers obtained from deacetylation of chitin, modified chitosan materials may also be used as flocculants in the present methods. Modified chitosan flocculants may include, but are not limited to, O-alkylated chitosan derivatives (e.g., glycol chitosan) and mono-N-substituted chitosan derivatives (e.g., N-alkylated chitosan, sugar-modified chitosan).

Beyond providing excellent thin stillage clarification results, the chitosan flocculants described herein are a “green” additive, i.e., they are biocompatible, antibacterial, environmentally friendly and meet GRAS/AAFCO/FDA regulations for use in animal feed in multiple markets. Because the chitosan flocculant is GRAS approved, it need not be removed and can be included in the distillers' grains (e.g., WDGS and/or DDGS) and be fed to livestock and/or other animals.

### Process Aid

The treatment system utilized herein to clarify thin stillage may also optionally include at least one process aid, which may be one or more of a secondary flocculant, a coagulant, a settling aid, and the like. Such process aids, when used as part of the treatment system described herein, may help to improve the agglomeration of suspended/dissolved solids in thin stillage, the stability of the floc generated, and/or the ease of separation by a particular solid-liquid separation device. For several examples of process aids that may be optionally used herein, see US2006/0057264 and US2007/0172913—each incorporated herein by reference in its entirety. Much like the chitosan flocculant, the decision of when to employ one or more process aids, the effective dosage, addition point(s), and mode of addition to the thin stillage process stream can be empirically determined by a person of ordinary skill in the art to obtain the best treatment program performance.

The secondary flocculant is different from the chitosan flocculant in that it is not chitosan based. The secondary flocculant may be a polymeric material, such as an anionic polymer, a nonionic polymer, and/or a cationic polymer, including both homo- and co-polymers thereof, or a non-polymeric material. Such secondary flocculants may include, but are not limited to,
water-soluble or water-swellable natural polymers or their derivatives including starch, starch derivatives (e.g., cationic starches such as quaternary ammonium type cationic starch and tertiary amino type cationic starch), inulin, inulin derivatives (e.g., cationic inulin such as quaternary ammonium type cationic inulin), soluble cellulosic polymers, plant gums, marine gums, microbial gums, and proteinaceous and polypeptide extracts;
synthetic anionic polymers formed from water-soluble ethylenically unsaturated monomers or monomer blends such as polymers formed from (meth)acrylic acid and its salts, maleic acid and its salts, itaconic acid and its salts, styrene sulfonate, and the like, as well as mixtures thereof;
cationic polymers formed from dialkylaminoalkyl (meth)acrylate type cationic monomers or monomer blends such as quaternary ammonium salt type monomers including dimethylaminoethyl (meth)acrylate methyl chloride quaternary salt (AETAC or METAC), dimethylaminoethyl (meth)acrylate methyl sulfate quaternary salt, dimethylaminoethyl (meth)acrylate benzyl chloride quaternary salt (AEDBAC), diethylaminoethyl (meth)acrylate methyl chloride quaternary salt, diethylaminoethyl (meth)acrylate methyl sulfate quaternary salt, diethylaminoethyl (meth)acrylate benzyl chloride quaternary salt, and the like, also including longer chain aminoalkyl groups (e.g., dialkylaminopropyl-, dialkylaminobutyl-), and mixtures thereof; as well as acid addition salt type monomers including dimethylaminoethyl (meth)acrylate sulfuric acid salt, dimethylaminoethyl (meth)acrylate hydrochloric acid salt, dimethylaminoethyl (meth)acrylate acetic acid salt, diethylaminoethyl (meth)acrylate sulfuric acid salt, diethylaminoethyl (meth)acrylate hydrochloric acid salt, diethylaminoethyl (meth)acrylate acetic acid salt, and the like, also including longer chain aminoalkyl groups (e.g., dialkylaminopropyl-, dialkylaminobutyl-), as well as mixtures thereof;
synthetic nonionic polymers such as polyethylene glycol, polyamides, polyethylene, poly(meth)acrylates, polyvinyl alcohol, polylactic acid, polycaprolactone, synthetic celluloses (e.g., carboxymethyl cellulose), and vinyl acetate homopolymers or vinyl acetate copolymers (e.g., vinyl acetate-ethylene copolymers, vinyl acetate-(meth)acrylate copolymers);
non-polymeric secondary flocculants such as and amino acids (e.g., lysine, ornithine, etc.) and organic sulfates (e.g., sodium dodecyl sulfate); and
mixtures thereof, including polymers made from different classes of monomers, for example, copolymers made from both anionic and nonionic monomers.

When employed, the secondary flocculant may be added to the thin stillage in dosages of at least 1 ppm, preferably at least 5 ppm, preferably at least 10 ppm, preferably at least 20 ppm, preferably at least 30 ppm, preferably at least 50 ppm, and up to 200 ppm, preferably up to 100 ppm, preferably up to 75 ppm, based on a total weight of the thin stillage.

A specific type of secondary flocculant that may be optionally employed herein is an acrylamide-based flocculant (acrylamide monomers, polyacrylamides formed from polymerization of an acrylamide monomer, or both). In some embodiments, for example when the primary objective is to deliver thin stillage with the highest degree of clarity (fewest solids), the methods may involve the use of an acrylamide-based flocculant in addition to the chitosan flocculant. In preferred embodiments, the methods disclosed herein do not involve the application of acrylamide-based treatments to stillage process streams, i.e., the treatment system is substantially free of acrylamide-based flocculants, and therefore the thin stillage stream after treatment with the treatment system is also substantially free of acrylamide-based materials. As a result, any solid feed products separated and collected from such thin stillage processing is also substantially free of acrylamide-based materials, which is advantageous from a toxicity standpoint.

The term “polyacrylamide” is loosely used to describe any polymer formed from an acrylamide monomer(s) component. For example, in many cases, a polyacrylamide is actually a copolymer of acrylamide and one or more other monomer types such as an acrylic acid or a salt thereof, but is nonetheless considered to be a polyacrylamide herein.

The acrylamide monomers, or the acrylamide monomers incorporated into polyacrylamides, may be nonionic, anionic, cationic, and/or Mannich-type acrylamide monomers (e.g., those mannich-type or quaternary mannich-type acrylamides described in U.S. Pat. No. 5,132,023A—incorporated herein by reference in its entirety). Representative acrylamide monomers include, but are not limited to, acrylamide, N-alkylacrylamide (e.g., N-methylacrylamide, N-ethylacrylamide, N-isopropylacrylamide), N,N-dialkylacrylamide (e.g., N,N-dimethylacrylamide, N,N-diethylacrylamide), N-alkylacrylamides with heteroatom substitution (e.g., N-(2-hydroxypropyl)acrylamide, N-methylolacrylamide, 2-acrylamido-2-methyl-1-propanesulfonate and salts thereof), N,N-dialkylacrylamides with heteroatom substitution, quaternized ammonium alkyl acrylamides (e.g., 3-acrylamidopropyltrimethylammonium chloride (ATAC)), as well as mixtures thereof. As mentioned previously, polyacrylamides which are preferably excluded from the methods herein may be made solely from one or more of these acrylamide monomers, or may be made from one or more of such acrylamide monomers in addition to monomers of other types (e.g., (meth)acrylate monomers).

The following are a few specific examples of acrylamide-based materials that may be preferably excluded from embodiments of the thin stillage processing methods of the present disclosure: TRAMFLOC products such as TRAMFLOC 307 (which is a medium molecular weight, moderately charged cationic polyacrylamide), TRAMFLOC 307A (which is a high molecular weight, moderately charged cationic polyacrylamide), and TRAMFLOC 108 (which is a medium molecular weight, moderately charged anionic polyacrylamide), each available from Tramfloc, Inc.; FLOPAM products such as FLOPAM AN 923 SH (which is an anionic 20:80 acrylate:acrylamide polyacrylamide of approximately 12 million MW), and FLOPAM FO 4490 SH (which is a cationic 40:60 ATAC:acrylamide polyacrylamide of approximately 6 million MW), each available from SNF, Inc.; as well as those acrylamide-based flocculants described in US20060006116A1, US2007/0210007A1, U.S. Pat. No. 9,776,105B2, U.S. Pat. Nos. 5,942,086, 6,131,331, 6,632,774, U.S. Ser. No. 11/473,004, US2009/0127205, and U.S. Pat. No. 5,891,254—each incorporated herein by reference in its entirety.

The methods of the present disclosure preferably do not involve the use of acrylamide-based flocculants because 1) the treatment system ultimately ends up in salable co-products as animal feed and acrylamide monomers are considered toxic, while polyacrylamides are a possible source of acrylamide monomers due to polymer degradation and/or residual monomer entrapment (Bratby, J., Coagulation and flocculation in water and wastewater treatment, IWA Publishing, London, 2006; Xiong, B. et al., Polyacrylamide degradation and its implications in environmental systems, Nature, npj Clean Water, 2018, 1, 17—each incorporated herein by reference in its entirety), 2) polyacrylamides returned as backset to the slurry tanks can build/cycle up in upstream processes and equipment, which can require shut down time for cleaning and can impact the nutritional value of the co-products used as animal feed, and 3) the thin stillage stream typically requires cooling prior to treatment to avoid polymer degradation, which increases energy costs and slows production.

In addition to acrylamide-based secondary flocculants, methacrylamide-based treatments may be optionally employed for thin stillage treatment herein. Preferably, the thin stillage processing does not involve the application of methacrylamide-based treatments, i.e., the treatment system is substantially free of methacrylamide-based flocculants (methacrylamide monomers, polymethacrylamides formed from polymerization of a methacrylamide monomer, or both). Methacrylamide monomers include, but are not limited to, the methacrylamide variants of any of the acrylamide monomers previously mentioned.

The process aid may be one or more coagulants such as water soluble polymeric coagulants, preferably water soluble cationic coagulants but said coagulants may contain any combination of cationic, nonionic, or anionic monomers, and/or inorganic coagulants. Such coagulants may include, but are not limited to,
chloro condensation polymers including epichlorohydrin-based polymers such as epichlorohydrin-dimethylamine (EpiDMA), for example, FLOQUAT FL 2749 (an EpiDMA polymer of 120,000 MW available from SNF, Inc.), epichlorohydrin-dimethylamine crosslinked polymers such as epichlorohydrin-dimethylamine-ammonia crosslinked polymers; ethylene dichloride-based polymers such as ethylene dichloride-ammonia polymers, ethylene dichloride-dimethylamine polymers, ethylene dichloride-dimethylamine-ammonia crosslinked polymers;
condensation polymers of multifunctional amines such as diethylenetriamine, tetraethylenepentamine, hexamethylenediamine and the like with ethylene dichloride and/or epichlorohydrin;
cationically charged vinyl addition polymers such as polymers and copolymers made from diallyl dialkylammonium salts (e.g., diallyldiethylammonium chloride, diallyldimethyl ammonium chloride (DADMAC)) for example FLOQUAT FL 45 C available from SNF, Inc., diallylmethyl-(β-propionamido)ammonium chloride; quaternized polyvinyllactam;
amide-reduction polymers such as allyl trialkyl ammonium salts (e.g., N,N,N-trimethylallylammonium methosulfate, and the like, for example those described in U.S. Pat. No. 4,053,512A—incorporated herein by reference in its entirety);
condensation polymers with formaldehyde such as melamine formaldehyde resins for example FLOQUAT FL42 available from SNF, Inc., dicyandiamide formaldehyde resins for example FLOQUAT DEC50 available from SNF, Inc., formaldehyde amine resins such as formaldehyde-dimethylamine and formaldehyde-ethylenediamine, for example MAGNAFLOC 1597 commercially available from BASF, optionally as protonated ammonium salts;
polyethylene imines (PEI), which may be oligomers or polymers with a repeating unit composed of an amine group and a two carbon aliphatic (—CH₂CH₂—) spacer, and may be linear polyethylene imines containing all secondary amines (with the exception of the terminal positions), or branched polyethylene imines containing primary, secondary and tertiary amino groups (e.g., LUPASOL available from BASF);
inorganic coagulants such as aluminum-based materials (e.g., aluminum sulfate (alum), aluminum chloride, polyaluminium chloride (PACl), aluminum chlorohydrate (ACH), sodium aluminate) and ferric- or ferrous-based materials (e.g., ferric sulfate, ferrous sulfate, ferric chloride);
and mixtures thereof.

The coagulant dosage may be adjusted depending upon a number of factors including, but not limited to, the type and amount of the chitosan flocculant employed, the solids in the thin stillage process stream, and the type of solid-liquid separation device employed. Typically, when the treatment system involves a coagulant, the coagulant is added to the thin stillage in dosages of at least 1 ppm, preferably at least 5 ppm, preferably at least 10 ppm, preferably at least 20 ppm, preferably at least 30 ppm, preferably at least 50 ppm, and up to 200 ppm, preferably up to 100 ppm, preferably up to 75 ppm, based on a total weight of the thin stillage.

The process aid may be one or more settling aids, preferably microparticulate settling aids with average particle sizes between 0.05 and 100 μm, preferably 0.1 and 50 μm. Settling aids are insoluble materials which when added to the thin stillage, physically interact with the suspended solids, fats, and oils and facilitate the separation and removal of these components by physical interaction. Without being limited by theory, settling aids may provide a surface area and sites where polymers can interact and bridge the suspended particles forming an agglomerated particle or a floc. Once the desired polymer-particle interaction is achieved the settling aid is designed to facilitate the separation process by increasing the rate by which the flocculated solids settle.

Exemplary settling aids may include, but are not limited to, bentonite, montmorillonite, diatomaceous earth, microsand (e.g., 80 mesh silica sand), colloidal silica, colloidal borosilicate, and the like. “Colloidal silica” and “colloidal borosilicate” mean a stable aqueous dispersion of amorphous silica particles or amorphous borosilicate particles, respectively, usually having a particle size less than about 100 nm.

When the treatment system involves the use of a settling aid, the settling aid may be added to thin stillage at a dosage of at least 10 ppm, preferably at least 20 ppm, preferably at least 30 ppm, preferably at least 50 ppm, preferably at least 75 ppm, preferably at least 100 ppm, preferably at least 150 ppm, preferably at least 200 ppm, preferably at least 300 ppm, preferably at least 400 ppm, and up to 1000 ppm, preferably up to 900 ppm, preferably up to 800 ppm, preferably up to 700 ppm, preferably up to 600 ppm, preferably up to 500 ppm, based on a total weight of the thin stillage.

In some embodiments, the treatment system involves only the use of the chitosan flocculant, and no process aids are added for the treatment of thin stillage.

In some embodiments, the treatment system involves a combination of the chitosan flocculant and one or more process aids (e.g., secondary flocculant, a coagulant, a settling aid). The chitosan flocculant and the process aid(s) may be added to the thin stillage simultaneously, either as a pre-mix, or added simultaneously as separate treatment streams. Alternatively, the chitosan flocculant and the process aid(s) may be added separately, for example in sequence. Yet in some cases, certain constituents of the treatment system may be added simultaneously, while others are added separately, for example, the chitosan flocculant and secondary flocculant(s) may be pre-mixed and added to the thin stillage together while the coagulant(s) and/or settling aid(s) are added as separate streams.

When the treatment system involves separate additions to the thin stillage, any order of addition may be performed. In some embodiments, when a coagulant is employed, the coagulant is added before the chitosan flocculant. The reverse order of addition is also possible and may be particularly suited to certain cases. In some embodiments, when a settling aid is employed, it is preferably added to the thin stillage prior to addition of the chitosan flocculant, and any secondary flocculant(s) and/or coagulant(s).

The thin stillage may be treated with the treatment system in a continuous fashion or a batch fashion, as a single treatment step or in multiple steps. In some embodiments, the treatment may be performed inline. In some embodiments, the treatment may be performed non-inline, for example by removing the thin stillage from the main pipeline, e.g., through the use of a slip line, treating the thin stillage, and then returning the treated process stream to the main pipeline. The treatment system may be added and mixed with the thin stillage upstream of the evaporator using any dosing/mixing techniques known by those of ordinary skill in the art, for example by using inline static mixers, inline mixers with velocity gradient control, inline mechanical mixers with variable speed impellers, inline jet mixers, motorized mixers or batch equipment, and appropriate dosing pumps and/or metering systems. Preferably, the treatment system is added through a high-sheer pump/mixing system.

### Separation

### Solid-Liquid Separation Devices

After the thin stillage is treated with a treatment system forming a mixture of water and flocculated solids, the water is next separated from the flocculated solids with a solid-liquid separation device(s) to form clarified thin stillage. Separation may be accomplished using any means capable of solid-liquid separation, including with a single solid-liquid separation device, or multiple solid-liquid separation devices, either in parallel or series, to achieve the desired effluent quality.

Examples of solid-liquid separation devices that may be used for this purpose include, but are not limited to, a dissolved air flotation (DAF) device; an induced air flotation (IAF) device; a settling tank; a flocculation device using induced velocity gradients generated from baffled chambers, granular media beads, spiral flow chambers, reciprocating blades, and/or rotating blades; a centrifuge such as a stacked disc centrifuge, a horizontal solid bowl centrifuge, a decanter, a tricanter, a SEDICANTER (available from Flottweg), and the like; a recessed chamber filter press; a rotary drum vacuum filter or other vacuum filter; a belt press; a pressure filter, and a membrane filtration device. Such devices can be horizontally-oriented devices such as horizontal centrifuges, horizontal shaft rotating blade flocculation devices, or vertically oriented devices such as vertical shaft rotating blade flocculation devices.

The total volume and overall sizing of the solid-liquid separation device(s) employed may be adjusted depending upon the type of separation, the number of solid-liquid separation devices utilized, the influent flow rate, the characteristics of the solids, the amount of solids present in the thin stillage, the desired effluent rate and quality, etc. Most solid-liquid separation devices operate with one combined influent stream into the unit and two or more discharge or effluent streams leaving the unit, although other configurations are also contemplated. Typically, the primary effluent stream is the clarified thin stillage which contains little to no solids, while the flocculated solids are concentrated and discharged as a second effluent stream for further processing.

In some embodiments, separation is accomplished with a low-shear solid-liquid separation device such as a settling tank, dissolved air flotation (DAF) unit, or IAF unit. In preferred embodiments, the solid-liquid separation device is a dissolved air flotation (DAF) unit or a series of DAF units.

Any dissolved air flotation unit known by those of ordinary skill in the art may be utilized in the methods herein, for example those described in U.S. Pat. Nos. 6,960,294, 5,693,222, 3,932,282, and 9,321,663—each incorporated herein by reference in its entirety. Generally, such devices introduce gaseous microbubbles into the process water, and the flocculated solids formed by addition of the chitosan flocculant and any optional process aid(s) as described above are rendered highly buoyant by the inclusion of such a gaseous phase. The gas may be air, nitrogen, methane, another hydrocarbon (e.g., propane), an inert gas, such as neon or argon, or another such gas, preferably air is typically used. The gaseous microbubbles may be introduced by aspiration or eduction (i.e., an atmospheric or near-atmospheric pressure system). In some embodiments, the gaseous microbubbles are introduced simultaneously with the treatment system including the chitosan flocculant. For example, the chitosan flocculant and a gas bubble stream may be introduced into the atmospheric opening of an eductor or other such device for generation of microbubbles. A dissolved air flotation (DAF) pump may be used. The gaseous microbubbles may also be released from a pressurized solution of dissolved gas, by reducing the pressure to atmospheric or near-atmospheric. In some embodiments, the release of gaseous microbubbles from solution may be performed simultaneously with, or more preferably prior to, introduction of the treatment system to the thin stillage. In this way, the microbubbles are present in the process stream when the chitosan flocculant begins to act on the dissolved/suspended solids, and, as the flocs form, the gaseous microbubbles are stably encapsulated within causing the flocs to float to the surface.

The flocculated solids may then be concentrated and recovered as a float layer, for example, by skimming or decanting the flocculated solids from a top surface of the clarified thin stillage, or by screening or filtration of flocculated solids from the clarified thin stillage. The clarified thin stillage (bottom layer) may also be decanted or drained from a lower level of the vessel. Other techniques may also be utilized to facilitate separation, for example, the mixture containing the distinct phases may be centrifuged or subject to high-volume, continuous-throughput screening.

### Other Method Description

In some embodiments, the method may be performed on all thin stillage leaving the whole stillage centrifuge. Alternatively, the method may be performed on only a portion of thin stillage leaving the whole stillage centrifuge. For example, it may be desirable to first split the thin stillage leaving the centrifuge into multiple streams, a first stream used for backset, and a second stream to be sent to the evaporators. In such cases, the first stream (thin stillage earmarked for backset) is preferably processed according to the disclosed methods to form a clarified thin stillage stream which is then sent back to the head of the plant as make-up water for the slurry tanks. The volume fraction of the first stream relative to the total amount of thin stillage leaving the whole stillage centrifuge may be for example at least 15%, preferably at least 20%, preferably at least 25%, preferably at least 30%, preferably at least 35%, and up to 50%, preferably up to 45%, preferably up to 40%, corresponding to the volume fraction of thin stillage typically used as backset.

Preferably, the method is practiced as a continuous process where a thin stillage stream is continuously treated with the chitosan flocculant and any process aid(s) and the resulting mixture is separated with the solid-liquid separation device(s) to form a continuous effluent stream of clarified thin stillage and, separately, concentrated flocculated solids. However, in certain instances it may be advantageous to operate the method as a batch treatment process, for example, where the thin stillage is removed from the main pipeline and treated with the treatment system in batches, and optionally aged, i.e., allowed to stand undisturbed or mixed for some period of time prior to being subject to separation.

After treatment, the thin stillage may be optionally aged for any amount of time to effect acceptable, substantial, or complete flocculation/aggregation, prior to subjecting the mixture to separation. Typical aging times are at least 1 minute, preferably at least 5 minutes, preferably at least 10 minutes, preferably at least 30 minutes, preferably at least 1 hour, and up to 10 hours, preferably up to 8 hours, preferably up to 6 hours, preferably up to 4 hours, preferably up to 2 hours. Optional heat (e.g., 135 to 180° F.) and/or pressure changes (e.g., pressure reduction) may also be applied during aging to enhance the flocculation/agglomeration processes, and therefore the flocculated solids capture during separation.

In some embodiments, a tank may be incorporated directly upstream of the separation device to promote enlargement of flocs during treating and/or aging operations. Exemplary tanks include, but are not limited to, mixing tanks (e.g., slow mix tanks, swirl tanks), skim tanks, settling tanks, and holding tanks.

In preferred embodiments, the thin stillage is treated with the treatment system (i.e., the chitosan flocculant and any process aids) and mixed in a slow mix tank prior to introduction to the solid-liquid separation device. The treatment can occur inline prior to the slow mix tank or in the slow mix tank itself, preferably inline just before the slow mix tank. While various configurations can be utilized, the thin stillage stream is preferably introduced through or near the bottom of the mixing tank where it is subjected to gentle mixing designed to enhance agglomeration of the particles. The mixing can be accomplished by any means suitable for the desired gentle mixing, for example, a variable speed mixer, a flat paddle prop etc. When a swirl tank is utilized, a “swirl” may be generated by directing the flowing stream along the inner surfaces of the tank, typically having a cylindrical shape, either at the bottom or elsewhere, to decrease turbulence of the fluids and to promote enlargement of the flocs.

After treating the thin stillage with the treatment system, and any optional aging, via a mixing tank or otherwise, the mixture thus obtained is then fed into the solid-liquid separation device(s). In some embodiments, the mixture is fed into the solid-liquid separation device(s) at an influent flow rate as low as 100 gallons per minute (gpm), preferably as low as 200 gpm, preferably as low as 300 gpm, preferably as low as 400 gpm, preferably as low as 500 gpm, preferably as low as 600 gpm, and as high as 2000 gpm, preferably as high as 1500 gpm, preferably as high as 1000 gpm, preferably as high as 900 gpm, preferably as high as 800 gpm, preferably as high as 700 gpm.

The resulting effluent (clarified thin stillage) contains little to no solids. Preferably the clarified thin stillage contains less than 3 wt. % solids (suspended and dissolved), preferably less than 2 wt. % solids, preferably less than 1 wt. % solids, preferably less than 0.8 wt. % solids, preferably less than 0.6 wt. % solids, preferably less than 0.5 wt. % solids, preferably less than 0.4 wt. % solids, preferably less than 0.2 wt. % solids, preferably less than 0.1 wt. % solids, preferably less than 0.05 wt. % solids, preferably less than 0.01 wt. % solids, preferably less than 0.001 wt. % solids. Since thin stillage generally contains 6 to 10 wt. % solids, the additional at least 3 wt. %, preferably at least 4 wt. %, preferably at least 5 wt. %, preferably at least 6 wt. %, preferably at least 7 wt. %, preferably at least 8 wt. %, preferably at least 9 wt. %, preferably at least 9.5 wt. %, preferably at least 9.9 wt. % of solids removed from this treatment may be combined with other co-products for improved yields of animal feed (e.g., WDGS and/or DDGS).

The thin stillage processing methods of the present disclosure may be applied to any ethanol manufacturing facility. While generally located downstream of the horizontal dewatering centrifuge (decanter) and upstream of the evaporator, the precise location of the solid-liquid separation device(s) within the ethanol production process (the location in which the separation is performed) can be determined and adjusted as needed to suit the needs of a particular plant/operation, for example, depending on the separation equipment already in place at the plant, the decision as to how the stillage stream will be split and processed in a particular plant, etc.

Some traditional ethanol production facilities are not equipped with, or do not include, integrated solid-liquid separation devices for thin stillage processing. In these plants, the thin stillage stream obtained from the centrifuge is normally routed directly to the evaporator and partially used as backset. Therefore, in some cases, the method herein may be practiced by adding/integrating a solid-liquid separation device(s) (e.g., a DAF device) into the plant, downstream of the existing horizontal dewatering centrifuge (decanter) and upstream of the evaporator for carrying out the water/flocculated solids separation.

In some embodiments, when a particular ethanol manufacturing facility already includes one or more solid-liquid separation devices for thin stillage processing, the separation step may be performed using the pre-existing solid-liquid separation device(s). The treatment system (dosages, process aids, etc.) may be adjusted as needed to best fit the type of solid-liquid device(s) already in place.

In some embodiments, when the ethanol manufacturing facility already includes one or more solid-liquid separation devices for thin stillage treatment, the method may be practiced by adding/integrating additional solid-liquid separation device(s) (e.g., a DAF device) for use in conjunction with the preexisting separation equipment.

In one example, the methods disclosed herein may be performed in an ICM, Inc. dry mill ethanol production plant, preferably in conjunction with the TS4 separation technology from ICM, Inc. The TS4 separation technology is designed to debottleneck the backend of corn ethanol plants, in part by incorporating a SEDICANTER (available from Flottweg) in between the existing whole stillage centrifuge (decanter) and the evaporators. The intermediary SEDICANTER splits the thin stillage stream into a solid fraction that gets routed to a wet conveyer and eventually the DDGS dryer or a wet pad, and a liquid stream that is sent to the evaporators.

The method may be practiced in conjunction with the TS4 system by introducing the treatment system to thin stillage leaving the whole stillage centrifuge and upstream of the SEDICANTER to form the mixture of water and flocculated solids, and then utilizing the SEDICANTER as the solid-liquid separation device for separating the water from the flocculated solids. Alternatively, the TS4 system may be supplemented with any of the aforementioned solid-liquid separation devices, preferably a DAF device, either directly upstream or downstream of the SEDICANTER, preferably directly downstream of the SEDICANTER. In some embodiments, the thin stillage stream leaving the SEDICANTER is treated with the treatment system, and a DAF device located downstream of the SEDICANTER and upstream of the evaporators is used as the solid-liquid separation device for forming clarified thin stillage and for recovering flocculated solids. In some embodiments, the thin stillage stream leaving the whole stillage centrifuge is treated with the treatment system, and the generated mixture is separated sequentially via a supplemental solid-liquid separation device (e.g., DAF unit) and SEDICANTER connected in series. Of course, the TS4 separation technology system is but one example of how the treatment methods may be integrated into ethanol production plants, and numerous other plant designs, configurations, modifications, and technologies are contemplated for carrying out the methods described herein.

The method may further involve recycling at least a portion of the clarified thin stillage as backset to slurry tanks for front-end mash and liquefaction processes. By removing solids from the thin stillage prior to recycling, the composition of the backset is materially changed. In prior art methods, the 6 to 10 wt. % solids present in untreated thin stillage are returned to the front of the plant within the backset. Unfortunately, suspended materials thereby continually increase in concentration each time the backset is recaptured, and as a result, the shear energy requirement placed on separation equipment such as the whole stillage centrifuge perpetually increases. This is because suspended solids distribute mass throughout the stillage and when the stillage undergoes shear forces in separation equipment, the suspended solids significantly increase the energy required to properly separate the suspended solids from the stillage. By removing much of the solids from thin stillage by the methods of the present disclosure, water savings can still be achieved (in fact more of this wastewater can be routed as backset), solids do not escape (more salable co-products are captured), and shear forces do not invariably rise. Further, removing solids from the thin stillage reduces the chances of impairing and/or poisoning upstream enzymatic processes due to high levels of organic impurities (for example high biological oxygen demand, BOD, and/or chemical oxygen demand, COD).

At least a portion of the clarified thin stillage may also be optionally concentrated in the evaporators to recover any small amount of dissolved and/or suspended solids remaining as condensed distillers' solubles (CDS), which may be blended with the wet distillers' grains from the whole stillage centrifuges to form wet distillers' grains with solubles (WDGS) for sale as animal feed. The reduced solids content of the clarified thin stillage is also advantageous for such concentration processes, as there is less likelihood of evaporator fouling.

The flocculated solids collected from the solid-liquid separation device(s) may be added to various process streams and/or co-products for increased yields of salable animal feed. For instance, the flocculated solids may be combined with the wet distillers' grains produced upstream during whole stillage processing in the horizontal dewatering centrifuge, and optionally sent to driers. The flocculated solids may also be added to the CDS leaving the evaporators. The flocculated solids may also be sent to the evaporators to remove residual moisture. In general, the additional solids obtained from the methods herein lead to higher overall yields of salable co-products such as WDGS and/or DDGS, as less solids are recycled as backset. The flocculated solids are also more concentrated and as a result the energy required for further processing is significantly reduced.

While the described disclosure speaks primarily to treating wastewater obtained from corn-to-ethanol operations, it may also be applied to wastewater produced from other fermentation processes to produce other fermentation products, as well as other industrial processes in the food industry, petrochemical industry, wet corn milling, and effluents from acidogenic anaerobic fermentation. Examples of other fermentation processes to which the described methods may be applied, include, but are not limited to, those utilizing biomass sources other than corn, such as rice, rye, barley, and malts, as well as those producing products such as glycerol, acetone, n-butanol, butanediol, isopropanol, butyric acid, methane, citric acid, fumaric acid, lactic acid, propionic acid, succinic acid, itaconic acid, acetic acid, acetaldehyde, 3-hydroxypropionic acid, glyconic acid and tartaric acid and amino acids such as L-glutamic acid, L-lysine, L-aspartic acid, L-tryptophan, L-arylglycines or salts thereof.

The examples below are intended to further illustrate thin stillage processing methods, and are not intended to limit the scope of the claims.

### EXAMPLES

### Thin Stillage Treatment Testing

Samples of whole stillage were obtained from ICM's pilot ethanol facility in St. Joseph, Mo. The whole stillage sample was centrifuged in the lab and the centrate was then tested for removing insoluble fractions that can later be utilized as a co-product.

Testing was performed with a dissolved air flotation (DAF) device using FREMONT 8374 as chitosan flocculant, which is an organic, cationic polymer with a degree of deacetylation (DD) of 86-87.6%, and a viscosity of 4,251 cP (as a 2 wt. % solution in 1 wt. % acetic acid) or 1,324 cP (as a 0.5 wt. % solution in 0.5 wt. % acetic acid).

Solutions were prepared by dissolving 20.6 mg of FREMONT 8374 in 1 mL of 1.68 M acetic acid (about 2 wt. % chitosan flocculant in 10 wt. % acetic acid), and the obtained solution was fed through a high sheer pump/mixing system and then allowed to slow mix with the centrate before entering a dissolved air flotation (DAF) device.

FREMONT 8374 created a stable floc that was capable of floating to the surface once in the dissolved air flotation system, with the best results being obtained from dosage of 20 to 50 ppm of FREMONT 8374.

The following economics are recommended based on a FREMONT 8374 dosage of 20 to 50 ppm:
650 gpm DAF feed rate
24 hours per day run time

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein. Persons skilled in the art will readily appreciate that the processes described above may in some instances be combined or separated into several steps. Furthermore, persons skilled in the art will also readily appreciate that the processes of this invention may be accomplished using a variety of equipment and techniques that are well known in the art. The specific equipment and processes used are not crucial so long as the intended result is accomplished

All patents and other references mentioned above are incorporated in full herein by this reference, the same as if set forth at length.

1. A method of processing thin stillage in an ethanol manufacturing operation comprising:
treating thin stillage upstream of an evaporator with a treatment system comprising a chitosan flocculant, thereby forming a mixture of water and flocculated solids; and
separating the water from the flocculated solids with a solid-liquid separation device to form clarified thin stillage.

2. The method of claim 1, wherein the chitosan flocculant is derived from chitin of animal sources.

3. The method of claim 1, wherein the chitosan flocculant is derived from chitin from fungal fermentation.

4. The method of claim 1, wherein the chitosan flocculant has a degree of deacetylation of 80 to 90%.

5. The method of claim 1, wherein the chitosan flocculant has a weight average molecular weight of 5,000 to 400,000 Daltons.

6. The method of claim 1, wherein the chitosan flocculant is introduced into the thin stillage in the form of an acidic solution comprising the chitosan flocculant and at least one acid selected from the group consisting of acetic acid, lactic acid, citric acid, adipic acid, malic acid, sulfuric acid, and hydrochloric acid.

7. The method of claim 6, wherein a weight percent of the chitosan flocculant in the acidic solution is from 0.5 to 2 wt. %, based on a total weight of the acidic solution.

8. The method of claim 1, wherein the chitosan flocculant has a viscosity of 2,000-5,000 cP, based on a 2 wt. % solution of the chitosan flocculant in an acidic solution of 1 wt. % acetic acid.

9. The method of claim 1, wherein the thin stillage is treated with 20 to 50 ppm of the chitosan flocculant, based on a total weight of the thin stillage.

10. The method of claim 1, wherein the treatment system further comprises at least one process aid selected from the group consisting of a secondary flocculant, a coagulant, and a settling aid.

11. The method of claim 1, wherein the thin stillage has a pH of 3 to 6.

12. The method of claim 1, wherein the thin stillage is treated when at a temperature of 65 to 95° C.

13. The method of claim 1, wherein the treatment system is substantially free of an acrylamide-based flocculant.

14. The method of claim 1, wherein the solid-liquid separation device is at least one centrifuge selected from the group consisting of a decanter, a tricanter, and a stacked disc centrifuge.

15. The method of claim 1, wherein the solid-liquid separation device is a dissolved air flotation device.

16. The method of claim 1, wherein the mixture is fed into the solid-liquid separation device at a feed rate of 400 to 800 gallons per minute.

17. The method of claim 1, further comprising aging the mixture for 1 minute to 10 hours prior to the separating.

18. The method of claim 1, wherein the clarified thin stillage contains less than 1 wt. % solids.

19. The method of claim 1, further comprising recycling at least a portion of the clarified thin stillage as backset to slurry tanks.

20. The method of claim 1, further comprising combining the flocculated solids with wet distillers' grains produced upstream during whole stillage processing.
